(19) United States
(12) Patent Application Publication
(10) Pub. No.: US 2017/0324228 A1
(43) Pub. Date: Nov. 9, 2017

(54) Grounding Clip

(71) Applicant: Eddie Garcia, Moorpark, CA (US)

(72) Inventor: Eddie Garcia, Moorpark, CA (US)

(21) Appl. No.: 15/147,627

(22) Filed: May 5, 2016

(51) Int. Cl. H02G 3/04; H01R 13/648; H01R 4/64; F16B 1/00; F16B 35/00; F16B 2/24; F16B 2/06; H01R 4/48

(52) U.S. Cl. CPC H02G 3/0406; H02G 3/04; H01R 13/648; H01R 4/646; H01R 4/48; F16B 1/00; F16B 35/005; F16B 2/24; F16B 2/065; F16B 2001/0064

(57) ABSTRACT

A resilient grounding clip including: a head having an aperture disposed in the head; a first leg having a proximate end connected to a first edge of the head, where the first leg is disposed at an obtuse angle relative to a first surface of the head; a second leg having a proximate end connected to a second edge of the head, where the second leg is disposed at an obtuse angle relative to the first surface of the head, and where the first edge is opposite the second edge; a first tab connected to the first leg at an end distal from the end connected to the head; and a second tab connected to the second leg at an end distal from the end connected to the head.

### TECHNICAL FIELD

The invention relates to cable runways, and more particularly to grounding cable runways.

### BACKGROUND

Cable runways are used to support cables in a horizontal cable run between racks and/or cabinets. Multiple cable runway sections may be connected to form extended horizontal cable runs. Each cable runway section must be electrically connected in order to ground the entire cable runway run. Existing methods of grounding involve grinding powder coated paint off of the surfaces of the cable runway in order to establish electrical contact via a grounding strap. This approach may result in particles that could interfere with the operation of expensive electronic equipment in the racks and/or cabinets. Additionally, this grounding process is time consuming, requires additional tools, and requires expertise to use these tools. Cable runways have been in use since around the 1960s and this approach to grounding adjacent cable runway sections has not been improved.

### SUMMARY

Exemplary system embodiments may include a grounding clip including: a head having an aperture disposed in the head; a first leg having a proximate end connected to a first edge of the head, where the first leg may be disposed at an obtuse angle relative to a first surface of the head; a second leg having a proximate end connected to a second edge of the head, where the second leg may be disposed at an obtuse angle relative to the first surface of the head, and where the first edge may be opposite the second edge; a first tab connected to the first leg at an end distal from the end connected to the head; and a second tab connected to the second leg at an end distal from the end connected to the head. In additional system embodiments, the grounding clip may be resilient. In additional system embodiments, the grounding clip material may be 1075 Spring steel. In additional system embodiments, a first surface of the first tab and a first surface of the second tab are in a plane parallel to a plane of the first surface of the head. In additional system embodiments, the first tab may be disposed at an acute angle relative to the first leg, and where the second tab may be disposed at an acute angle relative to the second leg. In additional system embodiments, the first tab may be disposed at a reflex angle relative to the first leg, and where the second tab may be disposed at a reflex angle relative to the second leg. In additional system embodiments, the distal end of the first leg and the distal end of the second leg are equidistant from a center of the aperture of the head. In additional system embodiments, the grounding clip may be symmetrical about a plane perpendicular to the first surface of the head.

Additional system embodiments may include a butt splice kit including: a first clamp including a first channel and an aperture; a second clamp including a second channel and an aperture; and a bolt; where the bolt of the butt splice kit may be disposed through the aperture in the first clamp, the aperture in the head of the grounding clip, and the aperture in the second clamp; where a second surface of the head may be disposed on top of the second clamp outside the second channel; and where the first leg and the second leg of the grounding clip are disposed within the first channel of the first clamp. In additional system embodiments, the first clamp may be identical to the second clamp. In additional system embodiments, the butt splice kit further includes: a washer; and a nut; where the bolt may be disposed through the washer, and where the nut may be rotatably secured to the bolt at a distal end of the bolt proximate to the second clamp.

Additional system embodiments may include a first cable runway section including two parallel stringers and a plurality of ladder rungs perpendicular to the two parallel stringers; a second cable runway section including two parallel stringers and a plurality of ladder rungs perpendicular to the two parallel stringers; where a first stringer of the first cable runway section may be disposed between the first clamp and the second clamp in the first channel and the second channel; where a second stringer of the second cable runway section may be disposed between the first clamp and the second clamp in the first channel and the second channel; where the first tab of the grounding clip contacts an inner wall of the first stringer; and where the second tab of the grounding clip contacts an inner wall of the second stringer. In additional system embodiments, an electrical connection between the first cable runway section and the second cable runway section may be established via the grounding clip. In additional system embodiments, the grounding clip may be resilient and deforms to maintain contact between the first cable runway section and the second cable runway section. In additional system embodiments, an outer surface of the first cable runway section includes a non-conductive coating, and where an outer surface of the second cable runway section includes the non-conductive coating. In additional system embodiments, the first stringer of the first cable runway section includes a first notch, where the second stringer of the second cable runway section includes a second notch, and where the head of the grounding clip may be disposed in the first notch of the first stringer and the second notch of the second stringer.

Another exemplary system embodiment may include a first grounding bracket including an L-shaped cross section, where a narrow portion of the first grounding bracket includes a first aperture; a second grounding bracket including an L-shaped cross section, where a narrow portion of the second grounding bracket includes a second aperture; and a set screw disposed in the first aperture of the first grounding bracket and the second aperture of the second grounding bracket; where rotation of the set screw increases a distance between the first grounding bracket and the second grounding bracket. Additional system embodiments may include a first cable runway section including two parallel stringers and a plurality of ladder rungs perpendicular to the two parallel stringers; a second cable runway section including two parallel stringers and a plurality of ladder rungs perpendicular to the two parallel stringers; where the first grounding bracket may be disposed in a first stringer of the first cable runway section; where the second grounding bracket may be disposed in a second stringer of the second cable runway section; where rotation of the set screw causes the first grounding bracket to contact an inner wall of the first stringer and the second grounding bracket to contact an inner wall of the second stringer; and where an electrical connection between the first cable runway section and the second cable runway section may be established via the first grounding bracket, second grounding bracket, and set screw.

An exemplary method embodiment may include positioning an end of a first cable runway section proximate to an end of a second cable runway section; inserting a bolt into an aperture of a first clamp including a first channel; placing the first channel of the first clamp over a first stringer of the first cable runway section and a second stringer of the second cable runway section; inserting a grounding clip into an inside of the first stringer and an inside of the second stringer, where the grounding clip contacts an inner wall of the first stringer and an inner wall of the second stringer, and where an aperture of the grounding clip may be inserted through the bolt; placing a second channel of a second clamp over the first stringer and the second stringer, where an aperture of the second clamp may be inserted through the bolt; and securing a fastener over an end of the bolt; where an electrical connection between the first cable runway section and the second cable runway section may be established via the grounding clip. In additional method embodiments, the grounding clip may further include: a head including the aperture disposed in the head; a first leg having a proximate end connected to a first edge of the head, where the first leg may be disposed at an obtuse angle relative to the head; a second leg having a proximate end connected to a second edge of the head, where the second leg may be disposed at an obtuse angle relative to the head, and where the first edge may be opposite the second edge; a first tab connected to the first leg at an end distal from the end connected to the head; and a second tab connected to the second leg at an end distal from the end connected to the head; where the first tab contacts an inner wall of the first cable runway section and the second tab contacts an inner wall of the second cable runway section.

### BRIEF DESCRIPTION OF DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a perspective view of a prior art grounding strap installed between two adjacent cable runway sections;

FIGS. 2A-2E depict perspective, front, top, bottom, and left side views, respectively, of an exemplary grounding clip;

FIGS. 3A-3B depict two alternate embodiments of exemplary grounding clips;

FIG. 4 depicts the exemplary grounding clip of FIGS. 2A-2E installed in a butt splice kit connecting two cable runway sections;

FIG. 5 depicts a cross-sectional view of the exemplary grounding clip, butt splice kit, and cable runway section of FIG. 4 across line A-A;

FIG. 6 depicts an exploded perspective view of the exemplary grounding clip and butt splice kit of FIG. 4;

FIG. 7A depicts an exemplary grounding clip installed in a butt splice kit connecting two exemplary cable runway sections having notches for fitting the grounding clip;

FIG. 7B depicts two exemplary cable runway sections having notches for fitting the grounding clip;

FIG. 8A depicts a perspective view of an exemplary grounding bracket for electrically connecting two adjacent cable runway sections;

FIGS. 8B-8C depict cross-sectional views of the exemplary grounding bracket of FIG. 8A in a non-deployed and a deployed state, respectively; and

FIG. 9 depicts an exemplary functional block diagram of a method embodiment for installing a butt splice kit with an exemplary grounding clip to electrically connect two adjacent cable runway sections.

### DETAILED DESCRIPTION

The disclosed device, system, and method allows for electrically connecting adjacent cable runway sections via a resilient grounding clip. The disclosed grounding clip includes a head with an aperture, a first leg, a first tab, a second leg, and a second tab. The grounding clip is inserted between a first clamp and a second clamp of a butt splice kit between adjacent stringers of adjacent cable runways. Tightening the clamps of the butt splice kit around the adjacent stringers deforms the grounding clip and causes contact of the first tab with an inner wall of a first stringer and causes contact of the second tab with an inner wall of a second stringer. Accordingly, the adjacent cable runways, ladder racks, and/or cable raceways made of hollow tubular steel are electrically connected and grounded without the need for special tools and/or training.

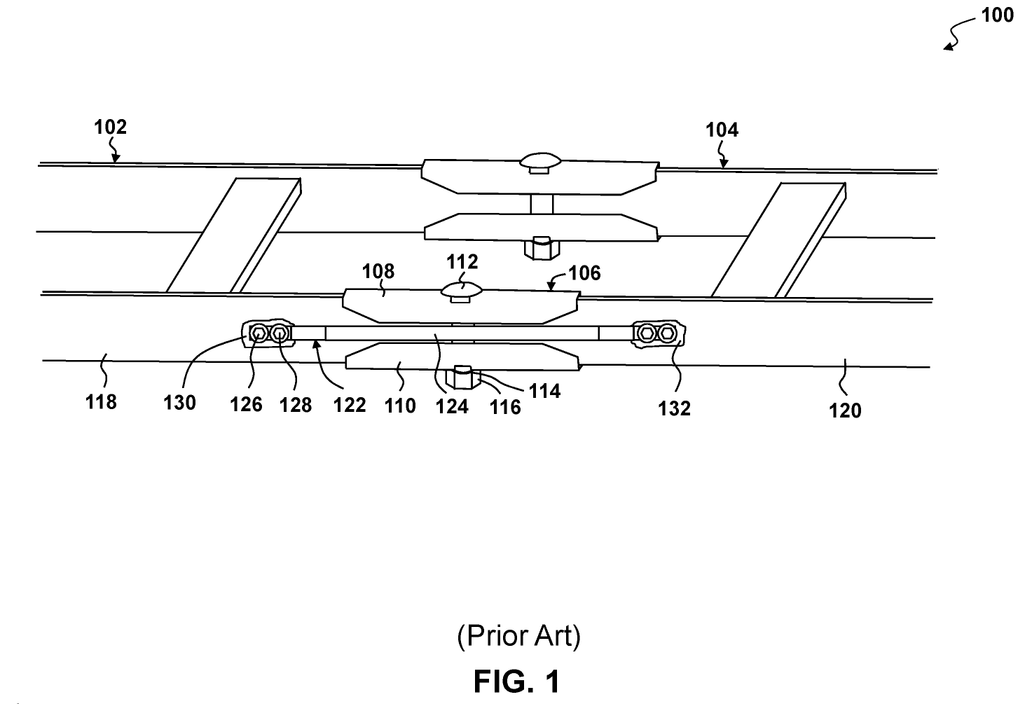

FIG. 1 depicts a perspective view of a prior art grounding strap installed between two adjacent cable runway sections 100. A first cable runway section 102 includes two parallel stringers and a plurality of ladder rungs perpendicular to the two parallel stringers. A second cable runway section 104 includes two parallel stringers and a plurality of ladder rungs perpendicular to the two parallel stringers. Each cable runway section (102, 104) may be supported from a floor and/or ceiling at a set distance, e.g., every five feet. The first cable runway section 102 may be identical to the second cable runway section 104. The cable runway sections (102, 104) may be connected via a butt splice kit (106), which may include a first clamp 108 having a channel and an aperture, a second clamp 110 having a channel and an aperture, a bolt 112 which goes through the apertures of the first clamp 108 and the second clamp 110, a washer 114, and a nut 116. Specifically, a first stringer 118 of the first cable runway section 102 may be connected to a second stringer 120 of the second cable runway section 104. Each of the two parallel stringers may be connected via a respective butt splice kit 106.

One side of the cable runway sections (102, 104) may be electrically connected to ground the entire cable runway. A grounding strap kit 122 may be installed between the first stringer 118 and the second stringer 120 to electrically connect the cable runway sections (102, 104). The grounding strap kit 122 includes a grounding strap 124 and a plurality of fasteners (126, 128), e.g., bolts, washers, split-lock washers, and nuts.

Most cable runway sections (102, 104) are powder coated and thus do not have an electrically conductive surface. In order to install the grounding strap kit 122, an installer has to use a high speed rotary tool to remove (130, 132) the powder coated paint from the surface of the stringers (118, 120) where the distal ends of the grounding strap 124 contact the stringers (118, 120). The installer may also have to drill holes into the stringers (118, 120) to accommodate the plurality of fasteners (126, 128).

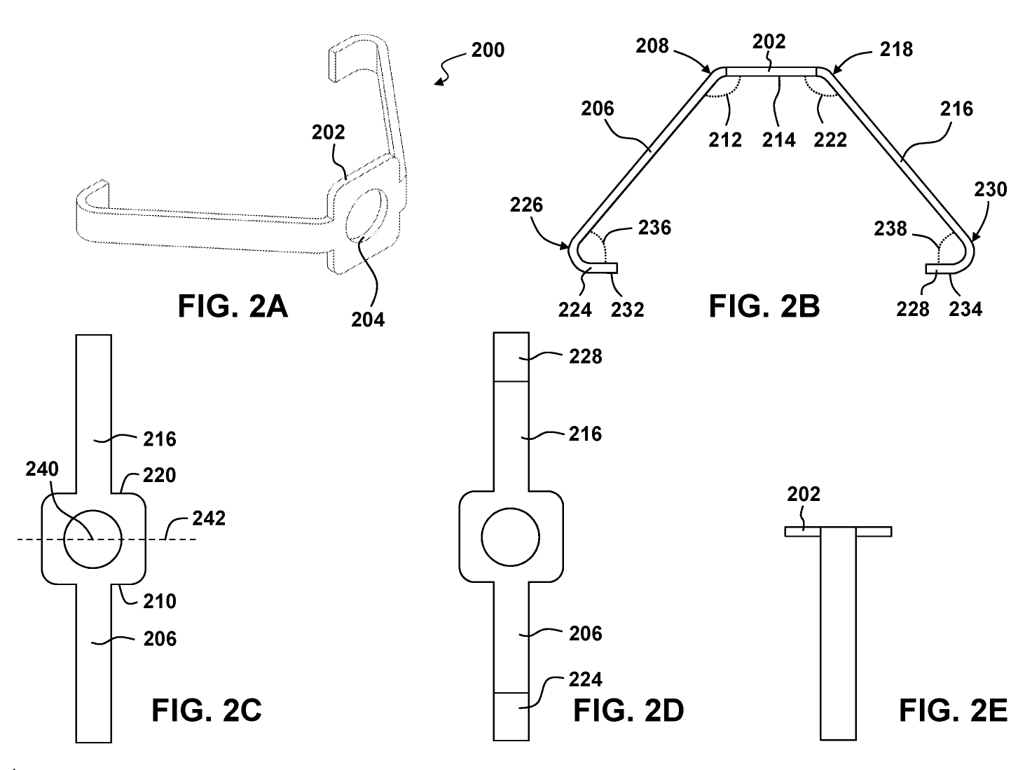

FIGS. 2A-2E depict perspective, front, top, back, and left side views, respectively, of an exemplary grounding clip 200. Angles are depicted as dotted lines with planes depicted as dashed lines. The grounding clip 200 includes a head 202 having an aperture 204 disposed in the head 202. The aperture 204 may be sized to fit a bolt of a butt splice kit. A first leg 206 of the grounding clip 200 has a proximate end 208 connected to a first edge 210 of the head 202. The first leg 206 is disposed at an obtuse angle 212 relative to a first surface 214 of the head 202. A second leg 216 of the grounding clip 200 has a proximate end 218 connected to a second edge 220 of the head 202. The second leg 216 is disposed at an obtuse angle 222 relative to the first surface 214 of the head 202. The angles (212, 222) of the first leg 206 and the second leg 216 relative to the first surface 214 of the head 202 may be identical. A first tab 224 of the grounding clip 200 may be connected to the first leg 206 at an end 226 distal from the end 208 connected to the head 202. A second tab 228 of the grounding clip 200 may be connected to the second leg 216 at an end 230 distal from the end 218 connected to the head 202.

The grounding clip 200 may be resilient, e.g., heat-treated 4130 steel, and capable of retaining its original shape after being deformed. A first surface 232 of the first tab 224 and a first surface 234 of the second tab 228 may be in a plane parallel to a plane of the first surface 214 of the head 202. The first tab 224 may be disposed at an acute angle 236 relative to the first leg 206. The second tab 228 may be disposed at an acute angle 238 relative to the second leg 216. The angles (236, 238) of the first tab 224 relative to the first leg 206 and the second tab 228 relative to the second leg 216 may be identical. In some embodiments, the distal end 226 of the first leg 206 and the distal end 230 of the second leg 216 may be equidistant from a center 240 of the aperture 204 of the head. The grounding clip 200 may be symmetrical about a plane 242 perpendicular to the first surface 214 of the head 202.

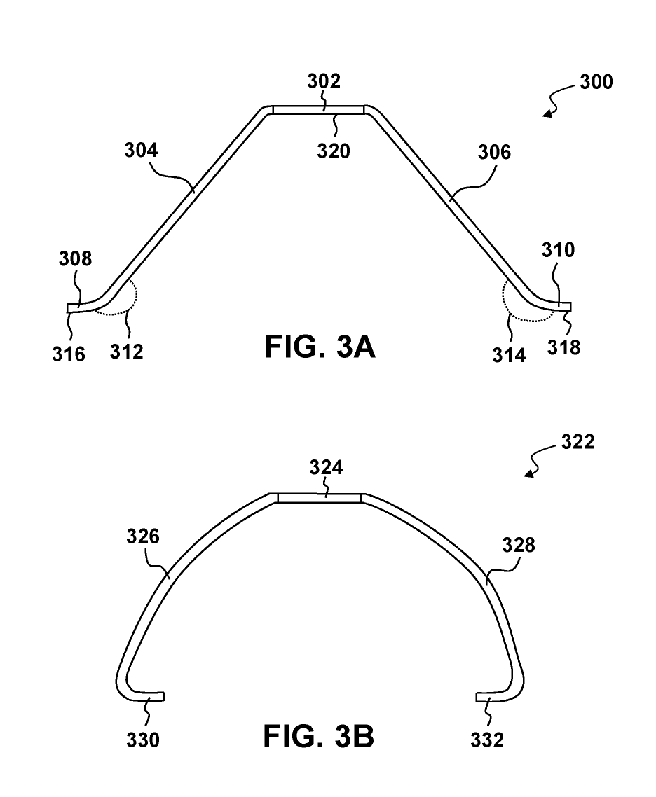

FIGS. 3A-3B depict two alternate embodiments of exemplary grounding clips. FIG. 3A depicts an exemplary grounding clip 300 having a head 302 with an aperture, a first leg 304, a second leg 306, a first tab 308, and a second tab 310. Angles are depicted as dotted lines. The first tab 308 may be disposed at a reflex angle 312 relative to the first leg 304. The second tab 310 may be disposed at a reflex angle 314 relative to the second leg 306. A first surface 316 of the first tab 308 and a first surface 318 of the second tab 310 may be in a plane parallel to a plane of the first surface 320 of the head 302. The angles (312, 314) may be identical. In some embodiments, the angles (312, 314) may be varied.

FIG. 3B depicts an exemplary grounding clip 322 having a head 324 with an aperture, a curved first leg 326, a curved second leg 328, a first tab 330, and a second tab 332. The legs (326, 328) of the grounding clip 322 may be substantially straight, curved, wavy, corrugated, or any other shape. Elements of the disclosed grounding clip may be combined, removed, and/or modified to electrically connect adjacent cable runways connected via butt splice kits. Embodiments are shown for grounding clips connecting cable runways at a straight, i.e., 180 degree, angle. However, the same principles disclosed herein may be applied to grounding clips for connecting between cable runways at non-straight angle, e.g., a 45 degree or 90 degree angle.

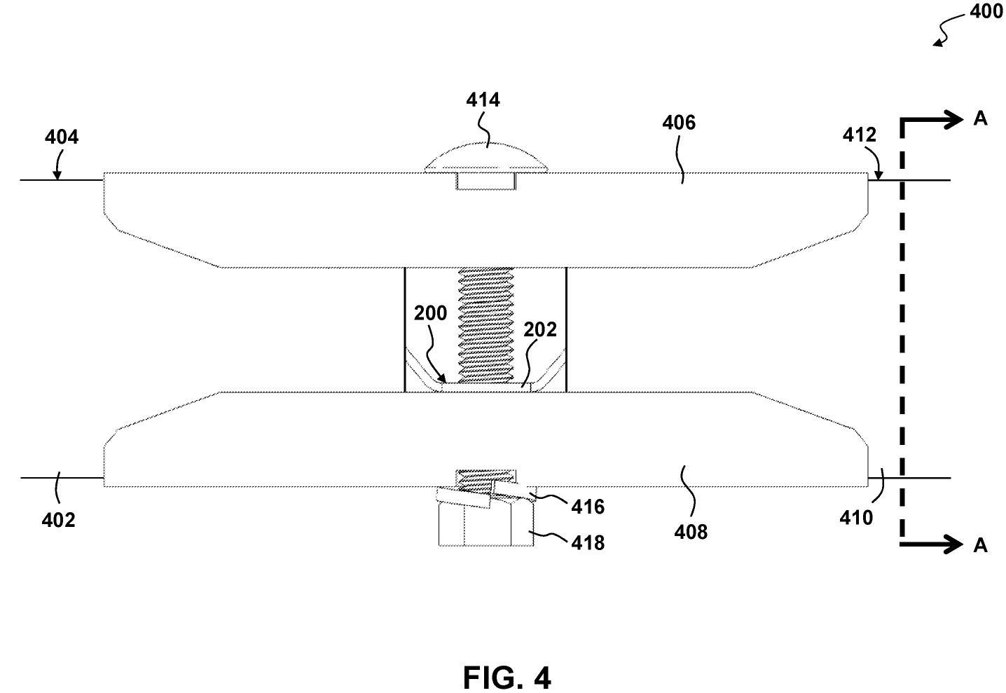

FIG. 4 depicts the exemplary grounding clip of FIGS. 2A-2E installed in a butt splice kit connecting two cable runway sections 400. A first stringer 402 of a first cable runway section 404 is disposed between a first clamp 406 and a second clamp 408, in a first channel of the first clamp 406 and a second channel of the second clamp 408. A second stringer 410 of a second cable runway section 412 is disposed between the first clamp 406 and the second clamp 408, in the first channel of the first clamp 406 and the second channel of the second clamp 408. The surface of each stringer is covered in a non-conductive material, e.g., powder coating and/or paint.

A bolt 414 is disposed through an aperture of the first clamp 406, an aperture in the head 202 of the grounding clip 200, and an aperture of the second clamp 408. A washer 416, e.g., a split-nut washer, and a nut 418 are rotatably secured to a distal end of the bolt 414 proximate to the second clamp 408. The head 202 of the grounding clip 200 is disposed on top of the second clamp 408 and outside the second channel. The first clamp 406 and the second clamp 408 may be identical.

The first tab of the grounding clip 200 contacts an inner wall of the first stringer 402. The second tab of the grounding clip 200 contacts an inner wall of the second stringer 410. Tightening the nut 418 about the bolt 414 compresses the clamps (406, 408) about the stringers (402, 410) and deforms the grounding clip 200 to force the tabs of the grounding clip 200 up against the inner walls of the stringers (402, 410). The grounding clip 200 may be resilient to maintain the tabs against the inner walls of the stringers (402, 410). A recessed portion of the inside of each stringer (402, 410) proximate to each open end may contain a non-conductive material, e.g., excess paint and/or powder coating during surface application. The geometry of the grounding clip 200 and position of each tab ensures that the tabs of the grounding clip 200 are contacting conductive surfaces, i.e., metal not covered by powder-coated paint, on the inner walls of each stringer (402, 410). The grounding clip provides an electrical connection between the first cable runway section 404 and the second cable runway section 412.

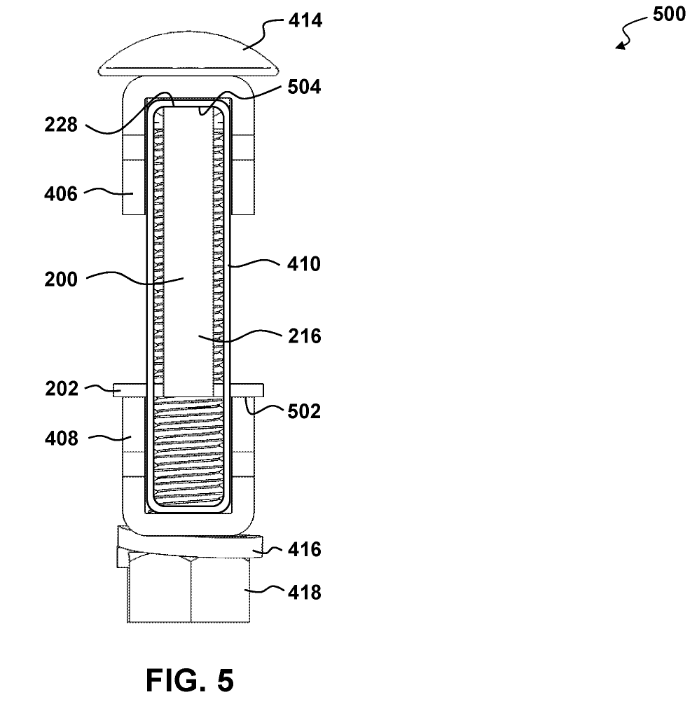

FIG. 5 depicts a cross-sectional view of the exemplary grounding clip, butt splice kit, and cable runway section of FIG. 4 across line A-A. The bolt 414 is disposed through the aperture of the first clamp 406, the aperture of the head 202 of the grounding clip 200, and the aperture of the second clamp 408. The bolt 414 is secured via a washer 416 and nut 418 proximate to the second clamp 408. As the nut 418 is rotatably secured about the bolt 414, the first clamp 406 and the second clamp 408 tighten around the second stringer 410. The head 202 of the grounding clip 200 has a greater width than the second channel of the second clamp 408. Accordingly, a second surface 502 of the head 202 is disposed on top of the second clamp 408. As the space between the first clamp 406 and the second clamp 408 is reduced during tightening of the nut 418, the grounding clip 200 will resiliently deform such that the first surface 228 of the second tab contacts an inner wall 504 of the second stringer 410. The same contact occurs on the other side of the grounding clip 200 between the first surface of the first tab and the inner wall of the first stringer.

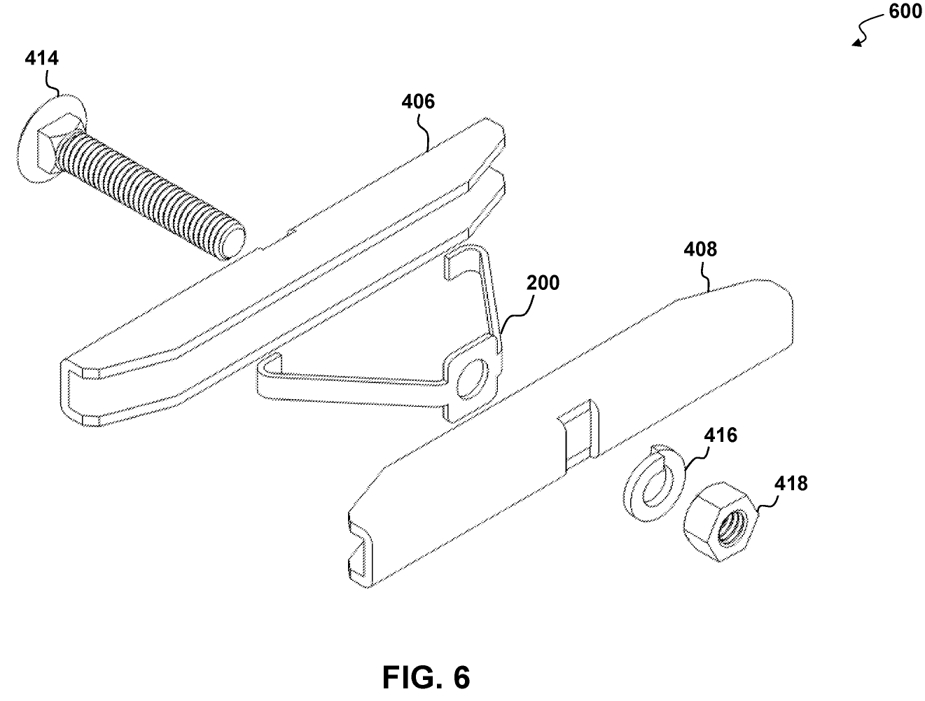

FIG. 6 depicts an exploded perspective view of the exemplary grounding clip and butt splice kit of FIG. 4 600. The butt splice kit includes the bolt 414, the first clamp 406, the second clamp 408, the washer 416, and the nut 418. The grounding clip 200 is disposed between the first clamp 406 and the second clamp 408 with the head of the grounding clip 200 resting on top of the second clamp. In some embodiments, the head of the grounding clip may be below the second clamp 408 and secured via the washer 416 and/or nut 418.

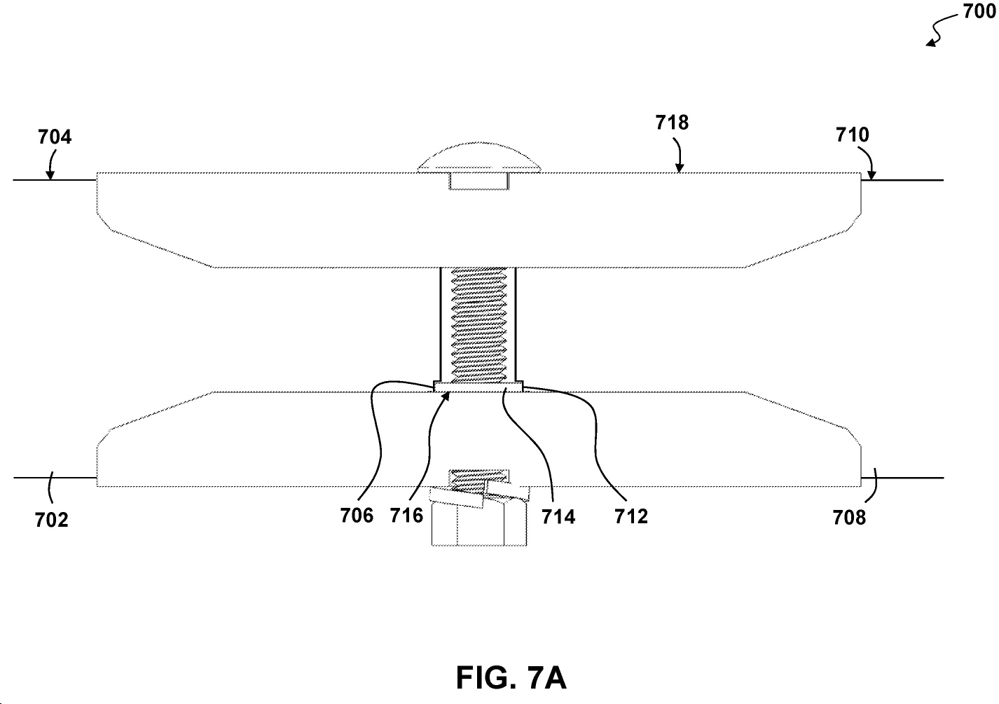

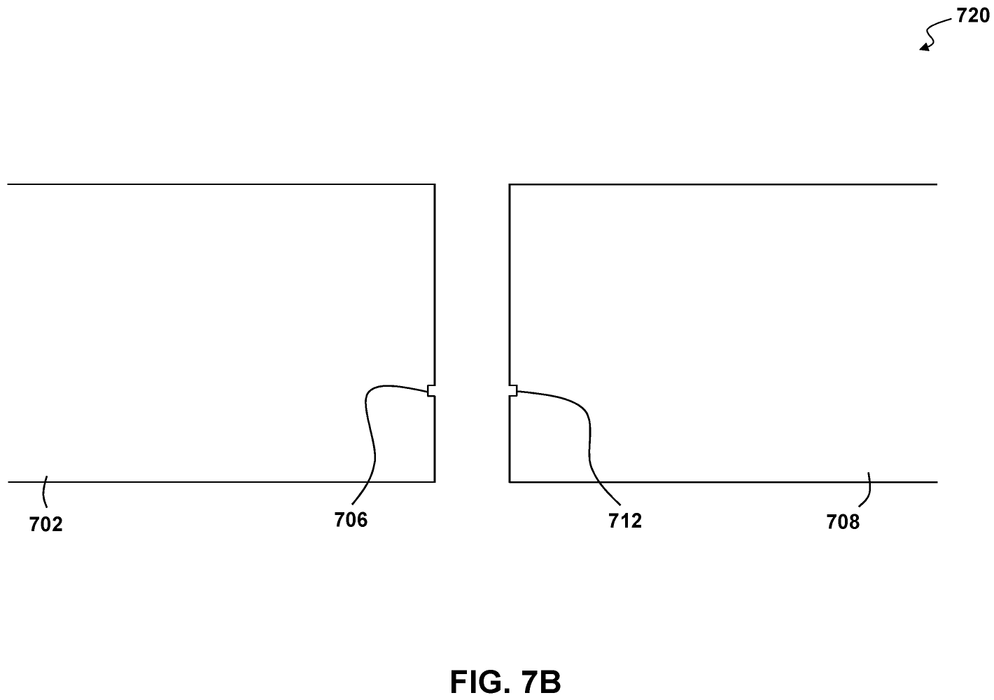

FIG. 7A depicts an exemplary grounding clip installed in a butt splice kit connecting two exemplary cable runway sections having notches for fitting the grounding clip 700. A first stringer 702 of a first cable runway section 704 has a first notch 706. A second stringer 708 of a second cable runway section 710 has a second notch 712. A head 714 of a grounding clip 716 may fit into the notches (706, 712). The notches (706, 712) may provide an alignment guide to an installer and may be present on one side, i.e., one stringer of the two parallel stringers in a cable runway. The notches (706, 712) may ensure that each of the stringers are properly spaced and/or positioned relative to the butt splice kit 718 and grounding clip 716 such that the tabs of the grounding clip 716 are not placed on a recess of an edge of a stringer that may have a non-conductive covering, such as a powder coating and/or paint. The notches (706, 712) may also serve as a visual confirmation that the grounding clip 716 has been installed and that the entire cable runway is properly grounded.

FIG. 7B depicts two exemplary cable runway sections having notches 720. The first stringer 702 has a first notch 706 and the second stringer 708 has a second notch 712. In some embodiments, only one of the stringers may have a notch. The notches (706, 712) in each stringer may be identical. The notches (706, 712) and grounding clip head (See FIG. 7A), are depicted as having a generally rectangular shape. In some embodiments, the notches and/or grounding clip head may be in any variety of shapes, number of faces, angle of faces, widths, and/or depths. The notches may create a snap fit with the grounding clip head upon sufficient tightening of a nut in the butt splice kit to indicate that installation is complete and proper to an installer.

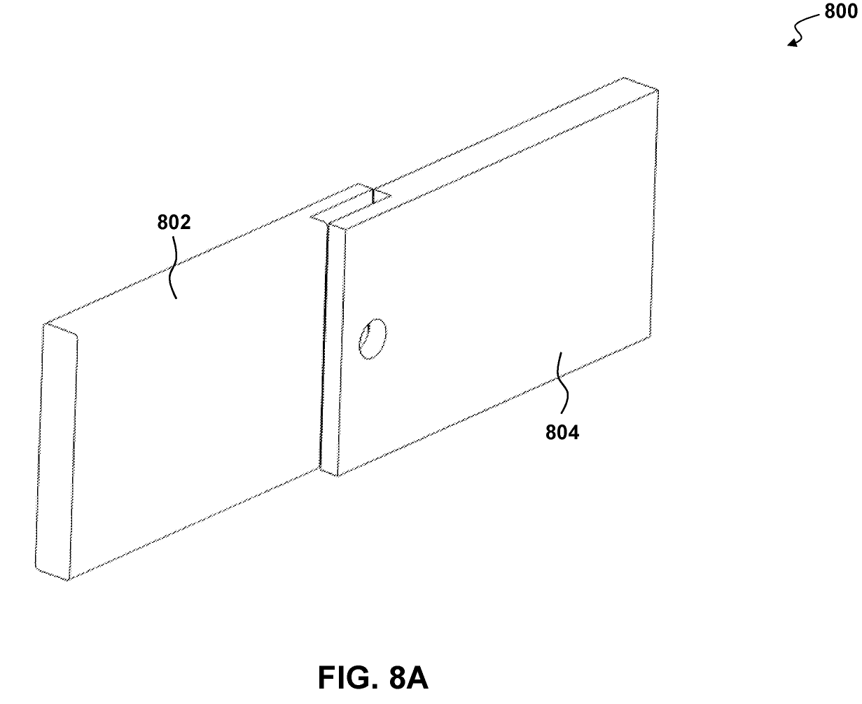

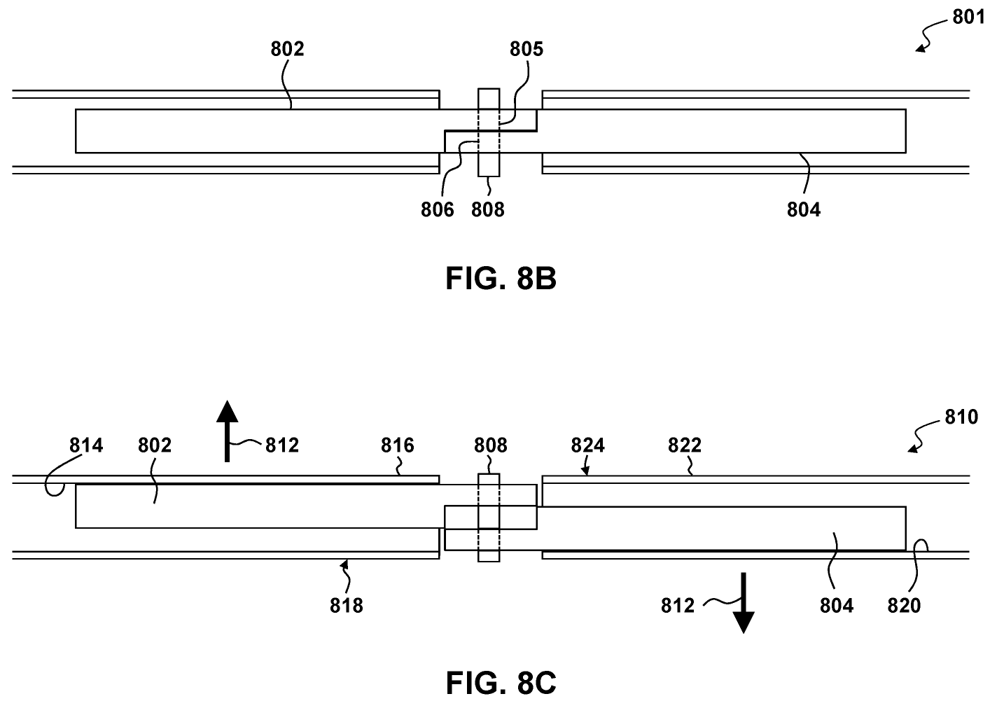

FIG. 8A depicts a perspective view of an exemplary grounding bracket for electrically connecting two adjacent cable runway sections 800. The exemplary grounding bracket 800 includes two brackets (802, 804). FIGS. 8B-8C depict the exemplary grounding bracket of FIG. 8A in a non-deployed and a deployed state, respectively. FIG. 8B depicts an exemplary grounding bracket in a non-deployed state disposed in two adjacent stringers 801. A first grounding bracket 802 has an L-shaped cross section and an aperture 805, depicted with dashed lines, disposed in a narrow portion of the first grounding bracket 802. A second grounding bracket 804 has an L-shaped cross section and an aperture 806, depicted with dashed lines, disposed in a narrow portion of the second grounding bracket 804. A set screw 808 is disposed in the aperture 804 of the first bracket 802 and the aperture 806 of the second bracket. The brackets (802, 804) may be identical and may nest together in the non-deployed state for ease of insertion into adjacent cable runway sections.

FIG. 8C depicts the exemplary grounding bracket of FIG. 8B in a deployed state disposed in two adjacent stringers 810. Rotation of the set screw 808 increases 812 a distance between the first grounding bracket 802 and the second grounding bracket 804. This increase 812 causes the first grounding bracket 802 to contact an inner wall 814 of a first stringer 816 of a first cable runway section 818, and causes the second grounding bracket 804 to contact an inner wall 820 of a second stringer 822 of a second cable runway section 824. An electrical connection between the first cable runway section 818 and the second cable runway section 824 is established via the first grounding bracket 802, the second grounding bracket 804, and the set screw 808.

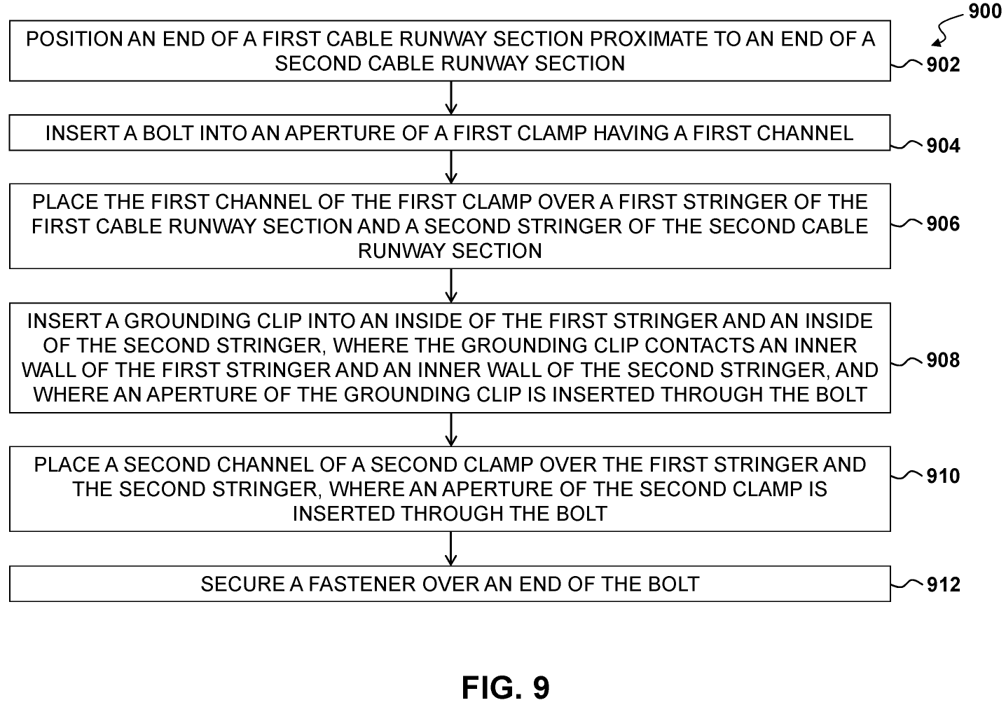

FIG. 9 depicts an exemplary functional block diagram of a method embodiment for installing a butt splice kit with an exemplary grounding clip to electrically connect two adjacent cable runway sections 900. An installer of the disclosed exemplary grounding clip does not need special tools, e.g., a high speed rotary tool to grind of a powder coating and drill to make holes, special qualifications, and/or special training to install the exemplary grounding clip. Additionally, the disclosed method for installing the disclosed grounding clip does not result in airborne particles, e.g., powder coating, paint and/or metal, that may damage expensive electrical equipment proximate to where the cable runway is being installed, e.g., a clean room and/or server room. An installer may position an end of a first cable runway section proximate to an end of a second cable runway section (step 902). An installer may then insert a bolt into an aperture of a first clamp having a first channel (step 904). The installer may then place the first channel of the first clamp over a first stringer of the first cable runway section and a second stringer of the second cable runway section (step 906). The installer may insert a grounding clip into an inside of the first stringer and an inside of the second stringer, where the grounding clip contacts an inner wall of the first stringer and an inner wall of the second stringer, and where an aperture of the grounding clip is inserted through the bolt (step 908). The installer may then place a second channel of a second clamp over the first stringer and the second stringer, where an aperture of the second clamp is inserted through the bolt (step 910). The installer then secures a fastener, e.g., a nut and washer, over an end of the bolt (step 912). An electrical connection between the first cable runway section and the second cable runway section is established via the grounding clip.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A system comprising:
a grounding clip comprising:
a head comprising an aperture disposed in the head;
a first leg having a proximate end connected to a first edge of the head, wherein the first leg is disposed at an obtuse angle relative to a first surface of the head;
a second leg having a proximate end connected to a second edge of the head, wherein the second leg is disposed at an obtuse angle relative to the first surface of the head, and wherein the first edge is opposite the second edge;
a first tab connected to the first leg at an end distal from the end connected to the head; and
a second tab connected to the second leg at an end distal from the end connected to the head.

2. The system of claim 1 wherein the grounding clip is resilient.

3. The system of claim 2 wherein the grounding clip material is 1075 Spring steel.

4. The system of claim 1 wherein a first surface of the first tab and a first surface of the second tab are in a plane parallel to a plane of the first surface of the head.

5. The system of claim 4 wherein the first tab is disposed at an acute angle relative to the first leg, and wherein the second tab is disposed at an acute angle relative to the second leg.

6. The system of claim 4 wherein the first tab is disposed at a reflex angle relative to the first leg, and wherein the second tab is disposed at a reflex angle relative to the second leg.

7. The system of claim 4 wherein the distal end of the first leg and the distal end of the second leg are equidistant from a center of the aperture of the head.

8. The system of claim 1 wherein the grounding clip is symmetrical about a plane perpendicular to the first surface of the head.

9. The system of claim 1 further comprising:
a butt splice kit comprising:
a first clamp comprising a first channel and an aperture;
a second clamp comprising a second channel and an aperture; and
a bolt;
wherein the bolt of the butt splice kit is disposed through the aperture in the first clamp, the aperture in the head of the grounding clip, and the aperture in the second clamp;
wherein a second surface of the head is disposed on top of the second clamp outside the second channel; and
wherein the first leg and the second leg of the grounding clip are disposed within the first channel of the first clamp.

10. The system of claim 9 wherein the first clamp is identical to the second clamp.

11. The system of claim 9 wherein the butt splice kit further comprises:
a washer; and
a nut;
wherein the bolt is disposed through the washer, and wherein the nut is rotatably secured to the bolt at a distal end of the bolt proximate to the second clamp.

12. The system of claim 9 further comprising:
a first cable runway section comprising two parallel stringers and a plurality of ladder rungs perpendicular to the two parallel stringers;
a second cable runway section comprising two parallel stringers and a plurality of ladder rungs perpendicular to the two parallel stringers;
wherein a first stringer of the first cable runway section is disposed between the first clamp and the second clamp in the first channel and the second channel;
wherein a second stringer of the second cable runway section is disposed between the first clamp and the second clamp in the first channel and the second channel;
wherein the first tab of the grounding clip contacts an inner wall of the first stringer; and
wherein the second tab of the grounding clip contacts an inner wall of the second stringer.

13. The system of claim 12 wherein an electrical connection between the first cable runway section and the second cable runway section is established via the grounding clip.

14. The system of claim 13 wherein the grounding clip is resilient and deforms to maintain contact between the first cable runway section and the second cable runway section.

15. The system of claim 13 wherein an outer surface of the first cable runway section comprises a non-conductive coating, and wherein an outer surface of the second cable runway section comprises the non-conductive coating.

16. The system of claim 12 wherein the first stringer of the first cable runway section comprises a first notch, wherein the second stringer of the second cable runway section comprises a second notch, and wherein the head of the grounding clip is disposed in the first notch of the first stringer and the second notch of the second stringer.

17. A system comprising:
a first grounding bracket comprising an L-shaped cross section, wherein a narrow portion of the first grounding bracket comprises a first aperture;
a second grounding bracket comprising an L-shaped cross section, wherein a narrow portion of the second grounding bracket comprises a second aperture; and
a set screw disposed in the first aperture of the first grounding bracket and the second aperture of the second grounding bracket;
wherein rotation of the set screw increases a distance between the first grounding bracket and the second grounding bracket.

18. The system of claim 17 further comprising:
a first cable runway section comprising two parallel stringers and a plurality of ladder rungs perpendicular to the two parallel stringers;
a second cable runway section comprising two parallel stringers and a plurality of ladder rungs perpendicular to the two parallel stringers;
wherein the first grounding bracket is disposed in a first stringer of the first cable runway section;
wherein the second grounding bracket is disposed in a second stringer of the second cable runway section;
wherein rotation of the set screw causes the first grounding bracket to contact an inner wall of the first stringer and the second grounding bracket to contact an inner wall of the second stringer; and
wherein an electrical connection between the first cable runway section and the second cable runway section is established via the first grounding bracket, second grounding bracket, and set screw.

19. A method comprising:
positioning an end of a first cable runway section proximate to an end of a second cable runway section;
inserting a bolt into an aperture of a first clamp comprising a first channel;
placing the first channel of the first clamp over a first stringer of the first cable runway section and a second stringer of the second cable runway section;
inserting a grounding clip into an inside of the first stringer and an inside of the second stringer, wherein the grounding clip contacts an inner wall of the first stringer and an inner wall of the second stringer, and wherein an aperture of the grounding clip is inserted through the bolt;
placing a second channel of a second clamp over the first stringer and the second stringer, wherein an aperture of the second clamp is inserted through the bolt; and
securing a fastener over an end of the bolt;
wherein an electrical connection between the first cable runway section and the second cable runway section is established via the grounding clip.

20. The method of claim 19 wherein the grounding clip further comprises:
a head comprising the aperture disposed in the head;
a first leg having a proximate end connected to a first edge of the head, wherein the first leg is disposed at an obtuse angle relative to the head;
a second leg having a proximate end connected to a second edge of the head, wherein the second leg is disposed at an obtuse angle relative to the head, and wherein the first edge is opposite the second edge;
a first tab connected to the first leg at an end distal from the end connected to the head; and
a second tab connected to the second leg at an end distal from the end connected to the head;
wherein the first tab contacts an inner wall of the first cable runway section and the second tab contacts an inner wall of the second cable runway section.
